(19) United States
(12) Patent Application Publication
(10) Pub. No.: US 2026/0048614 A1
(43) Pub. Date: Feb. 19, 2026

(54) METHOD FOR MANUFACTURING A BICYCLE RIM AND BICYCLE RIM

(71) Applicant: DT SWISS INC., Grand Junction, CO (US)

(72) Inventors: Andreas HENIG, Biel (CH); Anne Franziska SCHWARZ, Bettlach (CH)

(21) Appl. No.: 19/300,010

(22) Filed: Aug. 14, 2025

(30) Foreign Application Priority Data
Aug. 19, 2024 (DE) 102024123581.0

(51) Int. Cl. B60B 21/02; B29C 45/14; B29K 101/12; B29K 105/10; B29K 301/12; B29L 31/32

(52) U.S. Cl. CPC B60B 21/025; B29C 45/14631; B29K 2101/12; B29K 2105/10; B29K 2301/12; B29L 2031/32; B60B 2310/204; B60B 2360/341; B60B 2900/111

(57) ABSTRACT

A method for making a bicycle rim, having a rim body with at least one integrated cavity . The cavity is enclosed by a component wall. The rim body extends in a rim plane over 360° transverse to its rotational axis.

The cavity forms a chamber in the rim body. A plurality of component walls have two lateral rim flanks, a radial inner rim base and a radial outer rim well, which limit the chamber. A rim body support structure is formed by a fibre structure. A fibre bundle is attached to a carrier layer and passed reciprocally on the carrier layer to form a basic fibre layer of the fibre structure. The fibre structure is draped in a tool mould. A filling unit is placed in the tool mould so that the filling unit keeps the volume free for the cavity and the cavity is surrounded by the component wall.

### DESCRIPTION

The present invention relates to a method for manufacturing a bicycle rim with a rim body and at least one cavity integrated within it, a bicycle rim produced by such a method, and a bicycle rim with a rim body with at least one cavity integrated within it. In all its embodiments, the invention relates to a method for the manufacture of a bicycle rim and a bicycle rim, wherein the bicycle rim consists at least partially of a fibre composite.

In prior art, a wide variety of bicycle rims have become known that have a cavity in the form of a hollow chamber. Such bicycle rims also are often referred to as hollow chamber rims.

Bicycle rims are regularly made of lightweight materials and increasingly of fibre composites. In the production of bicycle rims made of fibre composites, it is possible for the matrix material to be injected into a cavity of a tool mould together with short fibres for reinforcement. This enables largely mechanical and automated production with consistent manufacturing quality. However, the disadvantage is that the stability and strength of the bicycle rims produced in this way is limited. This is mainly due to the short fibre pieces. This can be remedied by increasing the wall thickness and thus using more material overall. However, this in turn increases the total weight.

Another way to make bicycle rims from fibre composites is to use so-called prepregs, wherein pieces of fabric are impregnated with resin material. A large number of individual pieces of fabric are then placed in the tool mould and draped there. This allows a suitable wall thickness to be generated locally that takes into account the respective load. By draping the individual pieces in the tool mould, high quality and resilience can be achieved. The disadvantages of this method are the relatively high cost of the prepreg material used, the limited shelf life of the prepregs before processing, and also the high manual effort involved in production, which further increases costs.

It is therefore the object of the present invention to provide a method for the manufacture of a bicycle rim and a bicycle rim which comprises a component body as a rim body with at least one cavity integrated within it, wherein the rim body consists or is at least partially made of a fibre composite.

This task is solved by a method comprising the features of Claim 1 and by a bicycle rim comprising the features of Claim 15. Further advantages and features of the present invention can be found in the general description and the exemplary embodiments.

A method according to the invention is used for the production of a bicycle rim, wherein the bicycle rim comprises (at least) a (component body as) rim body with at least one cavity integrated within it. The cavity is enclosed all around by at least one surrounding component wall. The rim body extends in a rim plane over a circumference of 360° perpendicular to its rotational axis. The cavity forms a hollow chamber in the rim body. A plurality of component walls are formed, wherein the component walls comprise two lateral rim flanks, a radial inner (circumferential) rim base and a radial outer (circumferential) rim well, which delimit the hollow chamber. This means that the cavity can be designed as a completely enclosed hollow chamber. A support structure of the component body is formed by at least one fibre structure. To create the fibre structure, at least one fibre bundle is attached to a (thin) carrier layer with thread elements and guided back and forth on the carrier layer (or the carrier material) and in particular criss-cross in order to form a basic fibre layer or first fibre layer of the fibre structure. The carrier layer can form a base for building up the fibre structure. At least one fibre structure is draped in a tool mould. At least one filling unit is placed in the tool mould so that the filling unit keeps the volume free for the cavity during curing or solidification and is surrounded by the component wall. The filling unit is then regularly removed from the component body.

The method of producing a bicycle rim according to the invention has many advantages. A significant advantage is that the support structure is created by guiding and fastening a fibre bundle to a carrier layer in a targeted manner. This creates the fibre structure, which is manufactured according to the ideas and wishes in such a way that it can withstand the required conditions.

In particular, the fibre structure is produced by machine. The fibre bundle is positioned and guided by means of a machine and placed and attached to the carrier layer (as a base). The machine is controlled by an (integrated and/or separate) control device. This can significantly reduce manual effort and manual labour. Furthermore, the targeted production of fibre structures can significantly reduce the overall cost of parts, so that a large number of 50, 100 or 200 individual parts (fabric sections or prepregs) no longer have to be draped in the tool mould, but a single-digit number of fibre structures can be sufficient to produce the bicycle component in the form of the bicycle rim where applicable. By reducing the number of parts to be draped, the number of defects can be significantly reduced.

It is possible for the machine to deposit and attach two or more fibre bundles simultaneously. The positioning and attachment of, for example, two fibre bundles can be done simultaneously and also independently of each other.

The carrier layer can also be described as a base on which the fibre bundle is deposited and fastened in a targeted manner back and forth, and in particular criss-cross and preferably crossing each other.

In particular, the carrier layer is thin compared to a maximum wall thickness of the component body and, in particular, also thinner than a diameter of the fibre bundle deposited on the carrier layer. The fibre bundle preferably comprises at least two individual fibres and in particular a large number of parallel individual fibres forming a fibre roving. It is possible that the fibre bundle contains 1000, 10000 or 30000 or 50000 and more of the same or different individual fibres. In a concrete embodiment, a round fibre bundle with 36000 individual fibres has a diameter of about 2 mm (+/−about 25%) and in flat form a width of, for example, 5 mm and a corresponding height.

In preferential further embodiments, when at least one fibre structure is produced on the basic fibre layer (first level or first fibre level/fibre layer), at least one additional fibre layer is laid down and fastened at least in sections. As a result, another flat layer of fibre is applied and attached to the base fibre layer, so that the fibre structure is more strongly developed (reinforcement section) at defined sections than in other areas. This allows locally different and especially stronger forces to be dissipated in a targeted manner, or the support structure can be designed in such a way that the type and direction of acting forces (strength, direction, type: tension, compression, clamping, shear) are appropriately absorbed and dissipated.

The individual fibres of the fibre bundle preferably extend completely and in one piece through all areas of the fibre structure. If the fibre structure were made up of only a single fibre, the fibre would extend through all areas of the fibre structure from the first to the second end and everything would be formed in one piece, except for the thread element.

It is also conceivable that, after laying down a first fibre layer of a continuous fibre bundle, in particular, the fibre bundle is cut off. The head of the machine can then be repositioned and the same or a different fibre bundle can form a second fibre layer. Regularly, a fibre bundle extends continuously through the entire fibre structure. This makes production easier.

Preferably, at least one fibre bundle with a thread element is sewn or embroidered on the carrier layer or the carrier material or a fibre layer of the fibre structure. In particular, the fibre structure is produced using an embroidery machine in accordance with the TFP (Tailored Fibre Placement) principle.

Preferably, the thread element is at least partially made of a thermoplastic material. It is also possible to use other materials for the thread elements. The fibre bundle in all embodiments preferably comprises at least two fibres. The fibre bundle particularly prefers reinforcing fibres, which can be formed, for example, as carbon fibres or glass fibres and/or natural fibres or the like. The fibre bundle can also consist only of reinforcing fibres and not include other fibre types.

It is also possible and preferred that the fibre bundle includes fibres made of matrix material. In particular, the fibres made of matrix material are melted in the tool mould in order to form at least part of the component body together with the reinforcing fibres.

Preferably, the fibre structure includes continuous fibres. In particular, this means that all fibre layers and planes consist of or comprise a continuous fibre bundle.

In certain preferred embodiments, the carrier layer is removed after the fibre structure has been made. Then there remains a fibre structure that consists almost entirely or entirely of the fibre bundle and the thread elements, which connect individual sections and elements and parts of the fibre bundle with each other.

In general, the carrier layer does not serve to give stability to the fibre structure but serves (essentially or only) as a basis for applying and positioning the fibre bundle.

In preferred embodiments, it is possible for the carrier layer to include or consist of a fleece layer. It is also possible that the carrier layer comprises a film or a fibre fleece or is designed as such. With a fleece layer on the outer side of the component body, a high-quality surface can be provided when the component body or rim body hardens or solidifies.

In particular, the carrier layer may also comprise or consist of a layer of a thermoplastic material. Especially if a thermoplastic material is used as a matrix material, a carrier layer made of a thermoplastic material is favourable, as it becomes a matrix material directly during the manufacturing process. If the carrier layer is made of the same or a similar thermoplastic material as the matrix material, then the carrier layer will melt when heated and thus become matrix material.

Preferably, the fibre structures are pre-formed three-dimensionally and secured in their three-dimensional shape with a fibre binder and then inserted into the tool mould. For example, a teardrop-shaped liquid thermoplastic material can be used as a fibre binder, which binds the fibres locally to each other and thus provides sufficient support overall to insert the fibre material or the fibre structures, which has been preformed in a pre-form, for example, into the manufacturing mould in the correct form. This achieves a particularly high degree of accuracy. This can reduce the wall thickness where applicable, as uncertainties in the manufacturing process are reduced and stability is increased. A fibre binder can be made of different materials. It is possible, for example, to use a thermoplastic powder or a thermoset-based powder or, for example, also the use of a spray adhesive or the like.

With such a fibre binder, the two-dimensional (for example) embroidered semi-finished product (fibre structure) can be easily transferred into a 3-dimensional geometry that has sufficient stability for transfer to the tool mould for the production of the bicycle rim.

A film tube (or tube) can be used as the filling unit, which, after positioning in the tool mould and within the fibre structure, is inflated to form a counter mould. It is also possible to use a solid core as the filling unit, which is inserted into the tool mould. It is also possible for a (solid) core to form part of a filling unit. Or a combination of (solid) core and (inflatable) film tube is used. It is also possible to have a wax core that is covered with an air bag, which can then be inflated.

A film tube as a filling unit and/or a solid core as a filling unit can remain in it after the component body has been manufactured. Or the filling unit is removed again. An inflatable film tube (“bladder”) as a filling unit is usually not pressurized when inserted. Accordingly, the volume of the cavity is only fully filled by the filling body of the filling unit during the process (when inflated).

In favourable embodiments, the individual tool parts of the tool mould are closed and (supplementary) matrix material is injected. In particular, thermoset epoxy resin and/or a thermoplastic material can be used as matrix material.

The thread element can be retained in the rim body. It is also possible that the thread element is at least partially melted when the component body or rim body is completed. Then it is possible that the thread element as such is not completely retained in the component body. However, it can still be detected regularly during microscopic examinations. (Thin) reinforcing fibres can also be used as thread elements. The thread elements are thinner than the fibre bundle.

A bicycle rim with a rim body as a bicycle component has a rim body that extends in a rim plane over a circumference of 360° transversely or perpendicular to its rotational axis. The rotational axis is usually also a symmetry axis of the rim body. The cavity forms a (single) hollow chamber in the rim body, in particular one that is completely circumferential. A plurality of component walls are formed in the component body, wherein the component walls comprise two lateral rim flanks, a radial inner rim base and a radial outer rim well, which limit the hollow chamber.

Such a production of a bicycle rim is particularly favourable, as it enables stable and consistently high quality, high reproducibility and lower costs during production.

Preferably, at least one fibre structure extends over a considerable proportion of the circumference transversely or perpendicular to the rotational axis of the rim body. In particular, the fibre structure extends over at least a quarter or at least a third or at least half of the circumference and can extend particularly preferably over at least the complete circumference (of the rim body in the rim plane). A fibre structure that forms at least part of the rim well or the rim base, for example, can also extend over a circumferential angle of more than 360°. For example, there may be a certain overlap at the junction. However, it is also possible that the fibre structure extends over an angle of 720° or more, for example. Then the fibrous structure extends twice over the circumference.

In preferred embodiments, a (first) fibre structure (rim flank structure) forms an essential part of a rim flank. Another (second) fibre structure preferably forms a significant part of the other rim flank (rim flank structure). Another (third) fibre structure (rim well structure) preferably forms an essential part of the rim well. These three fibre structures can each extend fully around the rotational axis of the rim body. Even if a fibre structure extends completely over the circumference of the rim body, a rim flank can consist of or be composed of two or more fibre structures. This is the case, for example, if another fibre structure is applied in the area of the rim flanges.

Rim flanges are preferably formed radially outwards. In particular, a rim flange is formed by the fibre structure forming the rim flank (rim flank structure) and the further fibre structure (rim well structure), wherein the fibre structure forming the rim flank (rim flank structure) at the radial outer end covers and/or surrounds the further fibre structure (rim well structure) radially outwards.

In simple embodiments, this means that a rim flange is formed by the rim flank structure and the rim well structure, wherein the rim flank structure covers and/or surrounds the rim well structure radially outwards at the radial outer end. Two rim flank structures can be provided, namely one for each rim flank. Or a rim flank structure is used that extends over both rim flanks. The word or word component “structure” here refers to a fibre structure. In particular, the radial outer end of the rim flank structure is folded over and then extends radially back inwards over at least ⅕ or ¼ or preferably ⅓ or ½ or an even larger proportion of a radial height of the rim flange. As a result, the radial outer end of the rim well structure is protected by the rim flank structure. In addition, the free ends of the rim flank structure are also protected and are not directly exposed to impacts on the rim flange.

In the area of the rim flanges, an elastic cover and in particular a ring cover is particularly preferred on the tool mould. The tool mould is made of a less elastic material, and the cover is made of a more elastic (more elastic) material. This means that the cover can exert pressure and give way during curing. An ideal amount of material is not always exactly available in the production of a bicycle rim. The cover allows for compensation. With (slightly) too much material, the pressure on the wall of the rim flange is increased and the more elastic material of the cover (ring cover) is compressed more and with (slightly) less fibre composite material, the pressure is (slightly) reduced and the more elastic material of the cover is compressed less strongly. In both cases, sufficient pressure can still be applied in the event of certain deviations, so that a rim with high and improved quality can be produced.

In preferred further embodiments, the fibre structures forming the rim flanks are each designed in a circular ring. The fibre structures for the two rim flanks can be identical. However, it is also possible that the fibre structures forming the rim flanks each have the same outer diameter and different inner diameters. This is possible, for example, if the fibre structures of the rim flanks overlap in the area of the rim base.

A fibre structure that forms part of the rim well can be formed in particular as a strip. It is also possible that this fibrous structure is trough-shaped or gutter-shaped. In all cases, the fibre structure forming or contributing to the rim well can be applied in the form of a trough, even if the fibre structure itself has been produced in strips.

In favourable embodiments, it is possible to apply an additional, separate or additional fibre structure to the rim base. This is possible on the outer side as well as on the inner side. If the fibre structure is applied to the outer side, it is first inserted into the tool mould. If the fibre structure is to reinforce the rim base from the inside, the fibre structures that are to form the rim flanks are first inserted. Then the additional fibre structure is inserted to reinforce the rim base.

In all embodiments, it is preferred that the rim body of a bicycle rim consists at least partially of a fibre composite, wherein the fibres of the fibre composite are embroidered onto a foundation or a carrier layer.

In all embodiments and further embodiments of the invention, a (first) fibre structure forms at least one rim flank. Components of the (first) fibre structure may also be present in the rim flank. Preferably, the (first) fibre structure also forms (almost completely) the visible part of the rim flank. The (first) fibre structure can also be called (first) rim flank structure or (first) rim flank fibre structure. The (first) rim flank structure can also form or contribute to both rim flanks. It is also possible that a different (second) fibre structure forms the other rim flank. This other (second) fibre structure can then be called other (or second) rim flank structure or other (second) rim flank fibre structure.

In all embodiments and further embodiments of the invention, a further (third) fibre structure preferably forms at least the rim well. This further (third) fibre structure can also be called rim well structure or rim well fibre structure. In all embodiments and further embodiments of the invention, a different (fourth) fibre structure preferably supports the formation of the rim base. This other (fourth) fibre structure can also be called rim base structure or rim base fibre structure, or rim base part structure. This can be called rim base part structure, because this (fourth) fibre structure is usually only used for reinforcement. This rim base part structure can also be dispensed with.

In a specific embodiment, the method is used to produce a bicycle rim with a rim body with a hollow chamber integrated into it, which is bordered by two lateral rim flanks, a radial inner rim base and a radial outer rim well. A support structure of the rim body is formed by at least one fibre structure. First, at least one fibre structure is produced, wherein a fibre bundle with a large number of parallel individual fibres (in particular a fibre roving) is attached to a (thin) carrier layer (backing) with thread elements to produce the fibre structure. In particular, the fibre bundle is mechanically and automatically guided back and forth on the carrier layer or substrate and, in particular, criss-crossed, deposited and fastened in order to form a first level or base fibre layer of the fibre structure. With the fibre bundle, at least a second fibre layer or second fibre layer is laid down and fastened on the first layer or base fibre layer, at least in sections, in order to apply a flat (and overall three-dimensional) fibre structure to the carrier layer (underlay), which is more strongly developed at defined sections than in other areas. At least one fibre structure is draped in a tool mould. The fibre structure extends over a considerable proportion of a circumferential angle of a rim flank and, in particular, over at least 90° of the circumference.

This enables a simple, reliable and cost-effective production of a bicycle component and especially a bicycle rim.

A bicycle rim according to the invention comprises a component body as a rim body with at least one cavity integrated within it as a hollow chamber, wherein the cavity is enclosed all around by at least one surrounding component wall and wherein a support structure of the component body is formed by at least one fibre structure, wherein the fibre structure comprises a fibre bundle which runs back and forth within the fibre structure and is attached to each other with thread elements.

The component body is designed as a rim body and has two lateral rim flanks, a rim base and a rim well and a hollow chamber between the rim flanks, the rim base and the rim well. The rim body consists at least partially of a fibre composite, wherein the fibres of the fibre composite are sewn or embroidered on a carrier layer or on top of each other.

Overall, the invention enables cost-effective production and thus better competitiveness. Bicycle rims with a stable and consistently high quality can be produced and even offered at lower prices. Reproducibility is higher and waste can be reduced. It is possible to reduce manual labour and thus the need for personnel. Simultaneously, errors in the placement of individual pieces of fabric can be avoided, as the number of parts to be applied can be drastically reduced. It is not necessary to lay on 100 pieces of fabric or the like, but in the production of a bicycle rim it may be sufficient to drape 3, 4, 5 or perhaps 10 individual fibre structures in the tool mould.

Furthermore, reuse and recycling can be improved. Different starting materials can be used to meet the corresponding product-specific requirements. Impact resistance can also be improved.

The invention allows for partial automation or automation in manufacturing.

By depositing fibre bundles and attaching them using thread elements, finished, flat semi-finished products or preforms can be created, which are later assembled as fibre structures and result in a bicycle rim. In particular, dry fibres are used in the fibre bundle.

For the production of a bicycle rim, two tool halves and a ring device are used to form the rim well. The fibre structures can be connected to each other by overlapping. Ideally, the fibre structures are already produced three-dimensionally or pre-formed. Then the insertion can be done quickly and reliably.

To fill the cavity, a film tube and/or a solid core can be used as a filling unit.

The appropriately equipped tool mould can then be filled with thermoplastic matrix material or with a thermoset epoxy resin by means of RTM or by means of an infusion process. The mixture of fibres and matrix is solidified and hardened, for example. When using thermoplastic matrix material, the material can be heated afterwards to liquefy it and then solidify it again.

The carrier layer can be made of a film, a fibre fleece or the like. The carrier layer can be removed after the fibre structures have been manufactured or remains in the bicycle component as a possible visible surface or as a reinforcing material.

When using nonwovens, the flow property of a (for example) injected thermoset epoxy resin can be improved. A high-quality surface can be achieved. The surface of the bicycle rim can meet the required high-quality technical and optical properties, so that reworking is not necessary. This improves the cost-effectiveness of the method and the product.

In all embodiments, it is possible for the fibre bundle to include hybrid fibres, wherein some fibres consist of a matrix material, and other fibres consist of a reinforcing material. For example, individual fibres made of thermoplastic and carbon fibres may be contained in the fibre bundle. Then the required matrix material can already be partially or completely contained in the fibre bundle. The tool mould can then be heated accordingly, and the thermoplastic fibres can be fused to create a fibre composite component.

It is also possible to combine different raw fibres with each other, so that different carbon fibres with different mechanical properties can be deposited in a fibre structure. Then the ideal fibre can be used in each area depending on the stress or requirement of the product. It is also possible to use natural fibres or combine carbon fibres and other fibres, such as natural fibres, into a fibre blend.

Highly stressed areas of a bicycle component can be specifically reinforced in the direction of force flow by using an appropriate fibre structure.

It is also possible to absorb special loads by targeted fibre placement or to strengthen the component body accordingly. For example, ring-shaped or star-shaped reinforcements can be inserted around a spoke hole or a valve hole. Local reinforcements on bicycle rims of a spoke hole can go into the side wall (rim flank) and the horn area (rim flange).

It is also possible to form holes directly, for example, for a spoke hole or a valve hole or nipple holes. Then they no longer have to be drilled. Local reinforcements can be incorporated around the respective hole.

With the invention, it is also possible to produce other bicycle components, such as a cockpit with handlebars. Further advantages and features of the present invention result from the exemplary embodiments, which are explained below with reference to the enclosed figures.

The figures show:

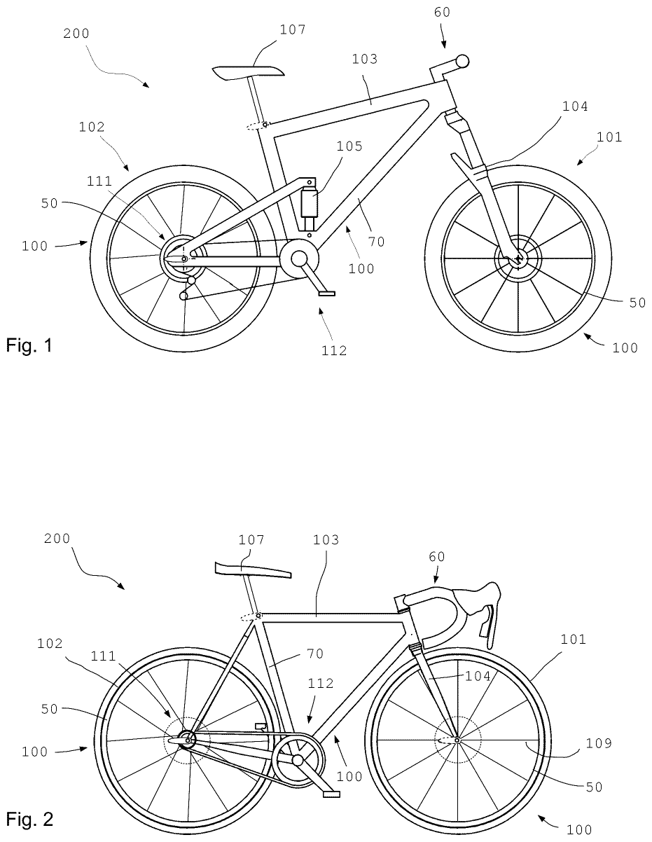

FIG. 1 a schematic illustration of a mountain bike with bicycle rims according to the invention;

FIG. 2 a schematic illustration of a racing bike with bicycle rims according to the invention;

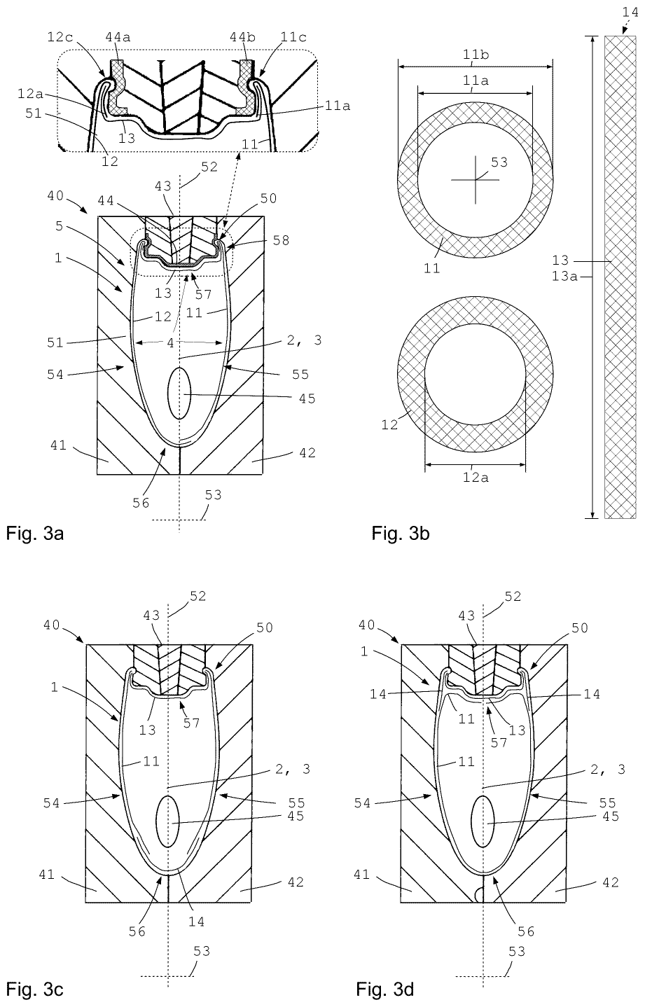

FIGS. 3a-3d schematic sections through a tool mould in the production of bicycle rims;

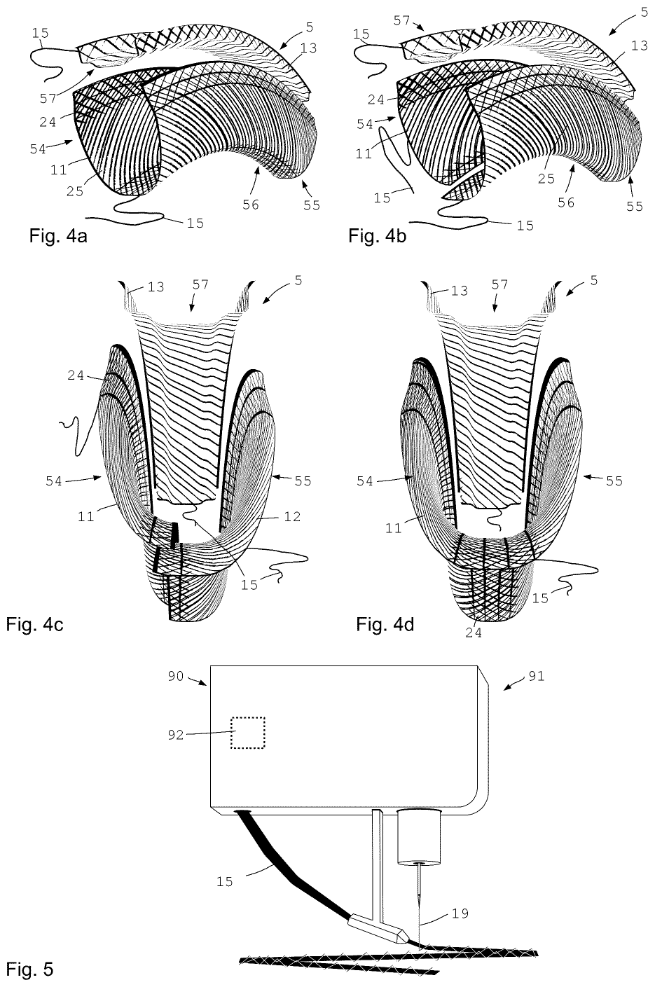

FIGS. 4a-5d schematic perspective illustrations of fibre structures in the production of bicycle rims;

FIG. 5 a machine for the production of a fibre structure for the bicycle rims according to the invention; and

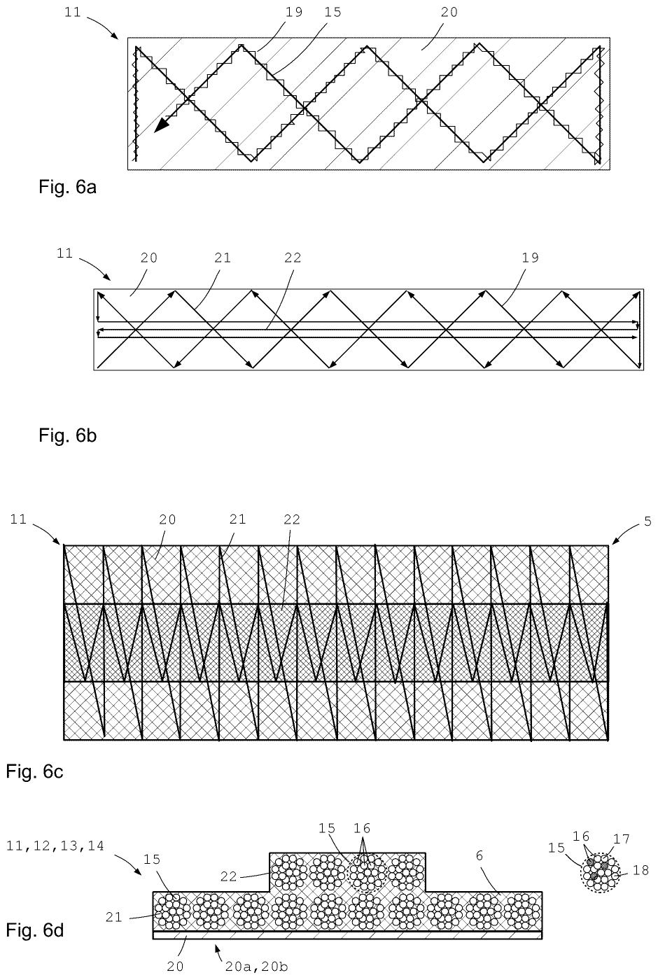

FIGS. 6a-6d fibre structures produced by the machine in accordance with FIG. 5.

FIGS. 1 and 2 depict bicycles 200, each of which has two bicycle rims 50 according to the invention. The mountain bike or road bike or gravel wheel 200 each has handlebars 60, a front wheel 101 and a rear wheel 102, each of which has bicycle rims 50 according to the invention. On the rear wheel 102 there is a sprocket device 111. The two wheels 101, 102 each have spokes 109. Conventional rim brakes or other brakes such as disc brakes can also be provided.

A bicycle 200 has a frame 103 that includes frame components 70. The bicycle 200 has a saddle 107, a fork or suspension fork 104 and, in the case of the mountain bike, a rear-wheel shock absorber 105 can be provided. A pedal crank 112 with pedals serves as the drive. If necessary, an electric auxiliary drive may be provided on the pedal crank 112 and/or the wheels where applicable.

In FIGS. 3a to 3d, various bicycle rims 50 can be seen as bicycle components 100 when manufactured in a tool mould 40. The bicycle rims 50 each have a single-piece rim body 1.

FIG. 3a shows a simple and very favourable design, in which two tool mould halves 41 and 42 are used for the tool shape 40, which are used to shape the rim flanks 54, 55, the rim base 56 and the rim flanges 58. Tool parts 43 can be used to shape the rim well 57.

FIG. 3a shows a cover 44 made of a more elastic material, which rests against the rim flanges 58 and the rim well 57. The cover 44, for example, is made of silicone and is inserted into the tool. The cover 44 allows for better production of the rim flanges 58. During production, it is important that the outer fibre structures 11, 12 cover or even surround the fibre structure 13 at the radial outer end of the rim flanges 58. In particular, the end 11a, 12a of the respective fiber structure 11, 12 is folded over and extends over ¼ or better ⅓ or ½ or an even larger proportion of a radial height of the rim flange radially back inwards. This protects the radial outer end of the fibre structure 13. In addition, the free ends 11a, 12a are also protected and are not directly exposed to impacts on the rim flange. This results in significantly better protection of the rim even in the event of strong impacts or high loads.

The fatigue strength is positively influenced if the fibre structures 11 and 12 surround the fibre structure 13 at the radial outer end (in the horn) and is extended around the fibre layer 13. The failure behaviour (damage pattern in the case of impact) is also positively influenced in this way. The bicycle rim is safer. This applies to all types of rims. To ensure that the rim flanges are optimally manufactured and compressed, the use of a more elastic cover in the form of a silicone ring, for example, is very favourable.

FIG. 3a (above) shows a variant in which the ends 11a, 12a extend back almost over the entire height of the rim flange. FIG. 3a (below) shows a variant in which the fiber structures 11, 12 extend radially inwards again over only part of the height. In both variants, the ends of the fibre structures are taken up in a protected manner.

Preferably, the fibre structures 11, 12 form the visible layers of the rim flanks.

FIG. 3a shows an enlarged variant above, which has two separate ring covers 44a, 44b, especially in the form of silicone rings, in order to optimally design and compress the rim flanges 58.

However, it is also possible that the use of silicone rings or other covers 44 or such inserts as is shown in FIGS. 3c and 3d, where a cover 44 is not drawn, is dispensed with. Preferably, one cover 44 (or two 44a, 44b) is used. Accordingly, then also in FIGS. 3c and 3d.

In a particularly simple and favourable embodiment, as shown in FIG. 3b, only three individual separate fibre structures 11, 12 and 13 are used to produce the bicycle rim 50. The fibre structures 11, 12 and 14 are produced in an adapted manner according to the method in accordance with FIGS. 6a, 6b, 6c and 6d. The finished fibre structures 11, 12 and 13 are placed in the tool mould 40 before it is sealed. Here, the fibre structure 11 forms the right rim flank 55, while the fibre structure 12 forms the left rim flank 54. In principle, a reverse embodiment is also possible, in which the fibre structure 12 forms the right rim flank 55 and the fibre structure 11 forms the left rim flank 54.

The fibre structures 11 and 12 are each formed in a circular ring, and each have the same outer diameter 11b. This outer diameter 11b is determined by the diameter of the rim flanges 58. The inner diameter 11a, 12a of the two fibre structures 11, 12 differs here, since the fibre structure 12 extends radially inwards not only to the central rim level 52, but also forms an overlap beyond it, and the other rim flank and fibre structure 11 overlap to reinforce the rim base 56.

FIG. 3c shows a cross-section, wherein it can be seen that the fibre structure 13 completely formed the rim well 57 and parts of the rim flanges 58.

The central rim level 52 is drawn. The same applies to the rotational axis 53, which forms a symmetry axis of the rim. The rim rotates around the rotational axis 53 in the intended normal operation. The rotational axis 53 is a symmetry axis of the rim, around which it extends in a rotationally symmetrical manner.

Inside the bicycle rim 50, a cavity 2 can be seen, which forms a hollow chamber 3 here. For example, when making the rim, a tube or core is placed inside the tool mould 40 as a filling unit 45 to fill the cavity 2 to be produced.

The cavity 2 is surrounded by the component walls 4, namely the rim flanks 54, 55, the rim base 56 and the rim well 57.

In the exemplary embodiment in accordance with FIG. 3a, three fibre structures 11, 12 and 13 were used for production. In the exemplary embodiment in accordance with FIG. 3c, a fourth fibre structure 14 is used, which serves to form and reinforce the rim base 56. In this case, it is not absolutely necessary for the fibre structures 11, 12 to extend radially inwards towards the rim base 56. In this exemplary embodiment as well, only very few fibre structures are used, since the fibre structures extend completely over the circumference around the rotational axis 53.

FIG. 3d shows another exemplary embodiment, wherein, for example, a fibre structure 11 is used here, which forms the rim flanks and the rim base. Furthermore, the fibre structure 11 also contributes to the stability of the rim well 57. A fibre structure 13 also contributes to the formation of the rim well 57. On the sides, two fibre structures 14 are drawn here to reinforce the rim flanges 58. A total of four fibre structures can be sufficient to produce the entire bicycle rim 50. Process reliability is significantly increased by the (very strongly) reduced number of fibre pieces to be (manually) inserted into the tool mould.

With reference to FIGS. 4a to 4d, vividly perspective representations of the fibre structures 11 to 14 used in the production of different bicycle rims 50 are shown as bicycle components 100. In FIG. 4a, only two different fibre structures 11 and 13 are used, wherein fibre structure 11 contributes to the formation of the rim flanks 54, 55 of the rim base 56. The fibre structure 13 contributes to the reinforcement of the rim flanges and the formation of the rim well 57. It can be seen that individual defined sections 24 serve as reinforcement sections, where an additional fibre layer has been applied to the base fibre layer or at least a lower fibre layer. Through the targeted application of the fibre bundle 15 or the fibre bundle 15 and the targeted three-dimensional structure of the fibre structures 11 to 14, a corresponding locally targeted reinforcement of the component body 1 can be carried out in each case.

Basically, a fibre bundle 15 extends completely through a respective fibre structure 11, 12, 13 or 14.

FIG. 4b shows a variant in which separate fibre structures 11, 12 are used for the two rim flanks. An additional fibre structure 13 is used to form the rim well 57.

FIG. 4c shows a variant in which two fibre structures 11 and 12 are provided for the formation of the rim flanks 54 and 55, while a fibre structure 13 is used to reinforce and form the rim well 57. In the lateral areas and also in the radial inner area, reinforcement sections 24 (defined sections) can be seen here, while there are also areas 25 that have a lower number of fibre layers than in reinforcement sections 24.

Finally, FIG. 4d shows a variant of a bicycle rim 50, in which the support structure 5 is formed by a fibre structure 11 and a fibre structure 13. The fibre structure 11 provides the two rim flanks 54 and 55 and the rim base 56, while the fibre structure 13 forms the rim well 57 and contributes to the stability of the rim flanges 58. Certain defined sections 24 have at least one additional fibre layer 22, while other areas 25 are not reinforced.

FIG. 5 shows a schematic view of a machine 90 for the prefabrication of fibre structures 11 to 14 (compare FIGS. 4a to 4d), wherein a fibre bundle 15 is unwound and fed from a roll. The machine 90 has a three-dimensionally movable machine head 91 (in x, y and z directions) and is controlled by an integrated and/or external control system 92. The fibre bundle 15 is specifically positioned and placed on a carrier layer 20 that is not visible in FIG. 3 (compare FIG. 4a) and attached there by means of a thread element 19.

In simple cases, the fibre bundle 15 can be attached to the carrier layer 20 by sewing and/or embroidery. A single thread element 19 can be used or an upper thread and a lower thread can be used as thread element 19.

FIGS. 6a to 6d show views of different fibre structures 11 to 14, which illustrate the principle.

In the case of the control system of machine 90, which is controlled in particular by computer technology, the head of the machine is positioned in such a way that fibre bundle 19 is positioned and moved in a targeted manner on the carrier layer 20.

The escaping fibre bundle 15 is attached to the carrier layer 20 with the thread element 19 or the thread elements 19, wherein the fibre bundle 15 is moved back and forth and in particular criss-cross over the carrier layer 20. In the process, the fibre bundle 15 is attached to the carrier layer 20. However, the fibre bundle 20 is also attached to itself at the intersecting points.

Overall, almost the entire (intended area of) carrier layer 20 is preferably covered with fibre bundle 15, resulting in a first fibre layer or base fibre layer 21, as FIG. 6b shows. A further fibre layer 22 is placed on top of it, wherein the individual fibres 16 (compare FIG. 4d) regularly extend in a single piece and completely through the base fibre layer 21 and the further fibre layer 22.

However, it is also possible that after the basic fibre layer 21 has been deposited, a separate or different fibre bundle 15 is used to deposit and attach another fibre layer 22 to the base fibre layer 21.

It is possible that the further fibre layer 22 with the thread elements 19 is attached directly and only on the first or basic fibre layer 21. However, it is also possible that the second fibre layer 22 is (also) attached to or to the carrier layer 20.

In all embodiments and embodiments, the carrier layer 20 is preferably thinner than a (minimal) diameter of a fibre bundle 15. In particular, a thickness of the carrier layer 20 is less than a quarter or even 1/10 of a (maximum) diameter of a fibre bundle 15. In all embodiments, a fibre bundle 15 can be circular, oval or square, square, rather flat or square with rounded corners, for example.

FIG. 6c shows a somewhat more complex fibre structure 11, in which two or also three fibre layers are deposited and attached to the substrate material or the carrier layer 20. Overall, the fibre structure 11 forms a support structure 5 for the bicycle component 100.

FIG. 6d shows a schematic cross-section through a support structure 5 or a fibre structure 11, 12, 13, 14, wherein the thin carrier layer 20 consisting of a fleece layer 20a and/or a film 20b with the base fibre layer 21 placed on it and the further fibre layer 22 positioned on it can be seen in the cross-section. Purely schematically, the fibre bundles 15 with the individual fibres 16 contained in them can be recognized. The individual fibres 16 can each be formed as reinforcing fibre 17 and/or as matrix fibre 18. Matrix fibres 18 are integrated especially when the bicycle component 101 uses thermoplastic matrix material. Then at least part of the required matrix material can be provided by fibre bundle 15.

FIG. 6d shows a strongly schematic cross-section of a finished product to show the principle. In this case, individual thermoplastic matrix fibres 18 and thermoplastic filament elements 19 may be dissolved and contained in the matrix material 6 and may no longer be easily or not at all visible to the naked eye in the section where applicable.

Overall, an favourable bicycle rim 50 is produced, which includes a one-piece rim body 1 with a hollow chamber 3, wherein only a small number (<15 and especially less than 9) fibre structures are used to reliably produce a lightweight and stable bicycle rim.

Reference list:

| | |
|---|---|
| 1 | rim body |
| 2 | cavity |
| 3 | hollow chambers |
| 4 | component wall |
| 5 | support structure |
| 6 | matrix material |
| 11 | fibre structure, rim |
| | flank structure |
| 11a | inner diameter |
| 11b | outer diameter |
| 12 | fibre structure, rim |
| | flank structure |
| 12a | inner diameter |
| 12b | end |
| 13 | fibre structure, rim |
| | well structure |
| 13a | length |
| 14 | fibre structure, rim |
| | base structure |
| 15 | fibre bundle, fibre |
| | roving |
| 16 | individual fibres |
| 17 | reinforcement fibre |
| 18 | matrix fibre |
| 19 | thread elements, thread |
| 20 | carrier layer, carrier |
| | material, (underlay) |
| 20a | fleece layer |
| 20b | film |
| 21 | basic fibre layer |
| 22 | additional fibre layer |
| 24 | defined section, |
| | reinforcement section |
| 25 | region (not reinforced) |
| 40 | tool mould |
| 41 | tool part |
| 42 | tool part |
| 43 | tool part |
| 44 | cover |
| 44a | ring cover |
| 45 | filling unit, core, tube |
| 50 | bicycle rim |
| 52 | rim plane |
| 53 | rotational axes |
| 54, 55 | rim sidewall (11, 12) |
| 56 | rim base (e.g., 14) |
| 57 | rim well (13) |
| 58 | rim flanges |
| 60 | handlebars |
| 70 | frame components |
| 90 | machines |
| 91 | machine head |
| 92 | control system |
| 100 | bicycle components |
| 101 | wheel, front wheel |
| 102 | wheel, rear wheel |
| 103 | frame |
| 104 | fork, suspension fork |
| 105 | rear-wheel shock |
| | absorber |
| 107 | saddle |
| 109 | spoke |
| 111 | sprocket device |
| 112 | pedal crank |
| 200 | bicycle |

1. A method for producing a bicycle rim comprising a rim body with at least one cavity integrated within it, wherein the rim body extends in a rim plane over a circumference of 360° transverse to its rotational axis, and wherein the cavity forms a hollow chamber in the rim body,; the method comprising:
wherein a plurality of component walls are formed, wherein the component walls comprise two lateral rim flanks, a radial inner rim base and a radial outer rim well, which delimit the hollow chamber;;
wherein a support structure of the rim body is formed by at least one fibre structure;
wherein for the production of the fibre structure a fibre bundle is attached to a carrier layer with thread elements and is passed back and forth on the carrier layer to form a basic fibre layer of the fibre structure; and
wherein at least one fibre structure is draped in a tool mould, and wherein one filling unit is placed in the tool mould so that the filling unit keeps the volume free for the cavity and is surrounded by the component wall.

2. The method according to claim 1, wherein at least one fibre structure extends over a considerable proportion of the circumference transversely to the rotational axis of the rim body and over at least one quarter.

3. The method according to claim 1, wherein a fibre structure forms a substantial part of at least one rim flank, and a further fibre structure forms the rim well.

4. The method according to claim 3, wherein a different fibre structure forms a substantial part of the other rim flank.

5. A method according to claim 1, wherein rim flanges are formed radially outwards, wherein a rim flange is formed by the fibre structure forming the rim flank and the further fibre structure, wherein the fibre structure forming the rim flank at the radial outer end radially covers or surrounds the further fibre structure radially outwards.

6. The method according to claim 1, wherein the fibre structures forming the rim flanks each have the same outer diameter and different inner diameters and wherein the fibre structures forming the rim flanks are each formed in a circular ring.

7. The method according to claim 1, wherein a fibre structure is applied to the rim base.

8. The method according to claim 1, wherein in the case of at least one fibre structure with the fibre bundle is deposited and fastened at least in sections on the basic fibre layer at least one further fibre layer in order to apply and fasten a flat further fibre layer on the base fibre layer, so that the fibre structure is more strongly developed at defined sections than in other areas.

9. The method according to claim 1, wherein the fibre bundle is sewn or embroidered with a thread element on the carrier layer or a fibre layer of the fibre structure and wherein at least one filament element consists of a thermoplastic material and wherein the fibre bundle comprises at least two fibres and wherein the fibre bundle comprises reinforcing fibres.

10. The method according to claim 1, wherein the fibre bundle comprises fibres of matrix material and wherein the fibres are melted from the matrix material to form together with the reinforcing fibres at least a part of the component body.

11. The method according to claim 1, wherein the carrier layer is removed after the fibre structure has been produced.

12. The method according to claim 1, wherein the fibre structures are pre-formed in three dimensions and secured in their three-dimensional shape with a fibre binder and then inserted into the tool mould.

13. The method according to claim 1, wherein the tool parts of the tool mould are closed, and matrix material is injected.

14. The method according to claim 1, wherein the thread element is retained in the component body or wherein the thread element is at least partially melted during the completion of the component body.

15. A bicycle rim with a rim body at least one integrated cavity;
wherein the rim body extends in a rim plane over a circumference of 360° transverse to its rotational axis,;
wherein the cavity forms a hollow chamber in the rim body;;
wherein a plurality of component walls are comprised, wherein the component walls comprise two lateral rim flanks, a radial inner rim base and a radial outer rim well, which limit the hollow chamber, wherein the cavity is enclosed all around by at least one surrounding component wall;;
wherein a support structure of the component body is formed by at least one fibre structure; and
wherein the fibre structure comprises a fibre bundle which is guided back and forth within the fibre structure and fastened (to each other) with thread elements, wherein the rim body consists at least partially of a fibre composite, wherein the fibres of the fibre composite are embroidered onto a carrier layer.
